(19) United States
(12) Patent Application Publication
(10) Pub. No.: US 2015/0358559 A1
(43) Pub. Date: Dec. 10, 2015

(54) DEVICE AND METHOD FOR MATCHING THERMAL IMAGES

(71) Applicant: HAO WANG, Hangzhou, Zhejiang (CN)

(72) Inventor: Hao Wang, Hangzhou (CN)

(21) Appl. No.: 14/758,253

(22) PCT Filed: Dec. 27, 2013
(86) PCT No.: PCT/CN2013/090632

§ 371 Date: Jun. 29, 2015

(30) Foreign Application Priority Data
Dec. 27, 2012 (CN) 201210584242.0

(51) Int. Cl. H04N 5/33; G06K 9/62; H04N 5/376; H04N 5/232; H04N 5/378

(52) U.S. Cl. CPC H04N 5/33; H04N 5/23206; H04N 5/23229; H04N 5/378; H04N 5/3765; G06K 9/6201

(57) ABSTRACT

This invention provides a device and method for matching thermal images, which relates to infrared detection. The conventional thermal imaging device is excessively dependent on subjective experience of users to photograph a thermal image of a photographed body during photographing, causing omissions and failing to ensure the quality of the photographed thermal image. In the invention, if there is a specified body thermal image in the photographed infrared thermal image may be detected, and when the specified body thermal image is detected, the identification is displayed, thus to inform the users. Thereby, the technical requirements for the users are reduced, the photographing quality and speed is improved, and the working strength is reduced.

### BACKGROUND OF THE INVENTION

1. Field of the Invention

The invention relates to infrared detection field and, more particularly, to a device and method for matching thermal images.

2. Description of the Related Art

Since thermal imaging detection is applied, users are always confused of recognition of an imaging shape of a body as a photographing part and a photographing angle are correct, which is dependent on subjective ideas and experience of the users. Thus, at present, if the detection quality needs to be ensured, the users need to think at the same time of photographing, thereby slowing a photographing speed. If the speed is accelerated, a key photographing part or defects of the body may be missed, affecting a state assessment effect. Usually the users can achieve the better detection level with practice accumulation for several years.

The technical persons in the field always try to solve this problem. Recently means for reducing the technical difficulties of thermal image photographing and improving the photographing speed are known.

In the prior art, a reference image reflecting morphological character of a photographed body and an infrared thermal image acquired by photographing are continuously overlapped and displayed, and users may photograph bodies with the visual reference of the reference image, to ensure the correction of the morphological character of the body thermal image in the infrared thermal image, thereby ensuring the photographing quality. For example, a patent with a publication number of CN201210008404.6 discloses the above device for photographing thermal images.

However, in the above method, the users may manually judge the matching extent between the reference image and the body thermal image by eyes, thereby easily causing visual fatigue and affecting the photographing speed.

Further, the limitation of the reference image for photographing is greater, such as shading the infrared thermal image, and the reference image may limit the position, dimension, or angle of the body thermal image, further increasing inconvenience of the users.

Therefore, a thermal imaging device capable of solving the problem in the prior art is needed.

### BRIEF SUMMARY OF THE INVENTION

The invention provides a device and method for matching thermal images. If there is a specified body thermal image in a photographed infrared thermal image can be detected. When the specified body thermal image is detected, an identification indicating a position of the body thermal image is displayed, thus to inform users, thereby facilitating the photographing operation, reducing the technical requirement for the users, improving the photographing quality and speed, reducing the work strength can be reduced, without excessively depending on the subjective ideas of the users, and facilitating the subsequent processing or operation such as analysis or storing.

This invention provides a device for matching thermal images including an acquiring part for photographing to acquire a thermal imaging data frame, a detecting part for detecting if there is a specified body thermal image based on the acquired thermal imaging data frame, and an image processing part for generating an infrared thermal image with an identification reflecting a position of the specified body thermal image located in the infrared thermal image according to a detecting result detected by the detecting part based on the acquired thermal imaging data frame.

This invention provides a device for matching thermal images including an acquiring part for acquiring a thermal imaging data frame, a detecting part for detecting if there is a specified body thermal image based on the acquired thermal imaging data frame, and an image processing part for generating an infrared thermal image with an identification reflecting a position of the specified body thermal image located in the infrared thermal image according to a detecting result detected by the detecting part based on the acquired thermal imaging data frame.

This invention provides a device for matching thermal images including an acquiring part for acquiring a thermal imaging data frame, a detecting part for detecting if there is a specified body thermal image based on the acquired thermal imaging data frame, and an identification generating unit for generating an identification reflecting a position of the specified body thermal image in an infrared thermal image according to a detecting result acquired by the detecting part and the thermal imaging data frame acquired by the acquiring part.

Further, the acquiring part may be used for continuously acquiring the thermal imaging data frame.

A method for matching thermal images in the invention includes an acquiring step for acquiring a thermal imaging data frame, a detecting step for detecting if there is a specified body thermal image based on the acquired thermal imaging data frame, and an image processing step for generating an infrared thermal image with an identification reflecting a position of the specified body thermal image located in the infrared thermal image according to a detecting result acquired in the detecting step, based on the acquired thermal imaging data frame.

These and other aspects and advantages of the present invention will be described with regard to the following description.

### BRIEF DESCRIPTION OF THE DRAWINGS

FIG. 1 is a block diagram showing a thermal imaging device 100 as an example of a device for recording thermal images in a first embodiment;

FIG. 2 is an outline diagram showing the thermal imaging device 100 in the first embodiment;

FIG. 3 is a schematic diagram showing body information and body identifying information stored in a storage medium in the first embodiment;

FIG. 4 is a schematic diagram showing detecting windows;

FIG. 5 is a schematic diagram showing detection via the multiple detecting windows;

FIG. 6 is a schematic diagram showing display interfaces in the first embodiment;

FIG. 7 is a flow chart of the first embodiment;

FIG. 8 is a schematic diagram showing a body contour and an analysis area as an identification;

FIG. 9 is a flow chart of a second embodiment;

FIG. 10 is a schematic diagram showing the identification in the second embodiment;

FIG. 11 is a schematic diagram showing the detection of two specified body thermal images and generation of the respective identification in the second embodiment;

FIG. 12 is a flow chart of a third embodiment.

### DETAILED DESCRIPTION OF THE INVENTION

This invention may be further described according to the drawings. For better understanding, the following described embodiments do not limit the scope of the invention and can be changed to different forms in the scope of the invention. Further, although a handheld thermal imaging device is taken for example, the photographing function in the invention is not necessary, and any thermal imaging data source may be used for performing detection of specified bodies. Therefore, the invention is widely applied to thermal image processing devices for reading and broadcasting or displaying and recording thermal images, or receiving and processing the thermal images from outside. The thermal image processing device may be different devices such as a personal computer or a personal digital assistant.

### Embodiment One

In the first embodiment, an thermal imaging device 100 detects correlation degree between an acquired thermal imaging data frame and body identifying information based on the thermal imaging data frame photographed by a photographing part 1, and generates an identification to inform users based on a position of a detected specified body thermal image.

FIG. 1 is a block diagram showing a thermal imaging device 100 as an example of a device for matching thermal images in the first embodiment of the invention.

In detail, the thermal imaging device 100 includes a photographing part 1, a temporary storage part 2, a flash memory 3, a communication I/F 4, a storage card I/F 5, a storage card 6, an image processing part 7, a detecting part 8, a display controlling part 9, a display part 10, a control part 11, and an operation part 12. The control part 11 is connected with each other part via a control and data bus 13, and is responsible for overall control of the thermal imaging device 100.

The photographing part 1 includes an optical part, a lens driving part, an infrared detector, and a signal preprocessing circuit, which are not shown. The optical part is composed of infrared optical lenses, and is used for focusing received infrared radiation on the infrared detector. The lens driving part drives the lenses to perform focusing or zooming operation according to a control signal of the control part 10, and the optical part may also be manually regulated. The infrared detector such as a refrigerating or non-refrigerated infrared focal plane detector converts the infrared radiation passing through the optical part to electrical signals. The signal preprocessing circuit, including a sample circuit, an AD conversion circuit, and a timing trigger circuit, performs signal processing such as sampling for the electric signals output from the infrared detector in a specified period. The signals are converted to digital thermal imaging signals by the AD conversion circuit. The thermal imaging signal may be 14-bit or 16-bit binary data (also called thermal imaging AD value data). In the first embodiment, the photographing part is as an example of an acquiring part for photographing to acquire thermal imaging data frames.

According to different embodiments of the acquiring part, the called thermal imaging data frame may be a thermal imaging signal (thermal imaging AD value data acquired after AD conversion of the output signal of the infrared detector), image data of an infrared thermal image, array data of a temperature value, or other data generated based on the thermal imaging signal. In the first embodiment, the called thermal imaging data frame may be the thermal imaging signal.

The temporary storage part 2, such as a RAM or DRAM volatile storage, is a buffer storage for temporarily storing the thermal imaging data frames output from the photographing part 1. For example, it may repeat the following processing, that is, temporarily store the acquired thermal imaging data frames to specified time sets, and delete the previous data frames to store new thermal imaging data frames when the acquiring part (the photographing part 1) acquires the new frames. Meanwhile, the temporary storage part 2 is a working storage of the image processing part 7, detecting part 8, and the control part 11, for temporarily storing the processed data of the image processing part 7 and the control part 11. However, the invention is not limited. A storage or register in the processor such as the image processing part 7, the detecting part 8, or the control part 11 may also be defined as a temporary storage medium.

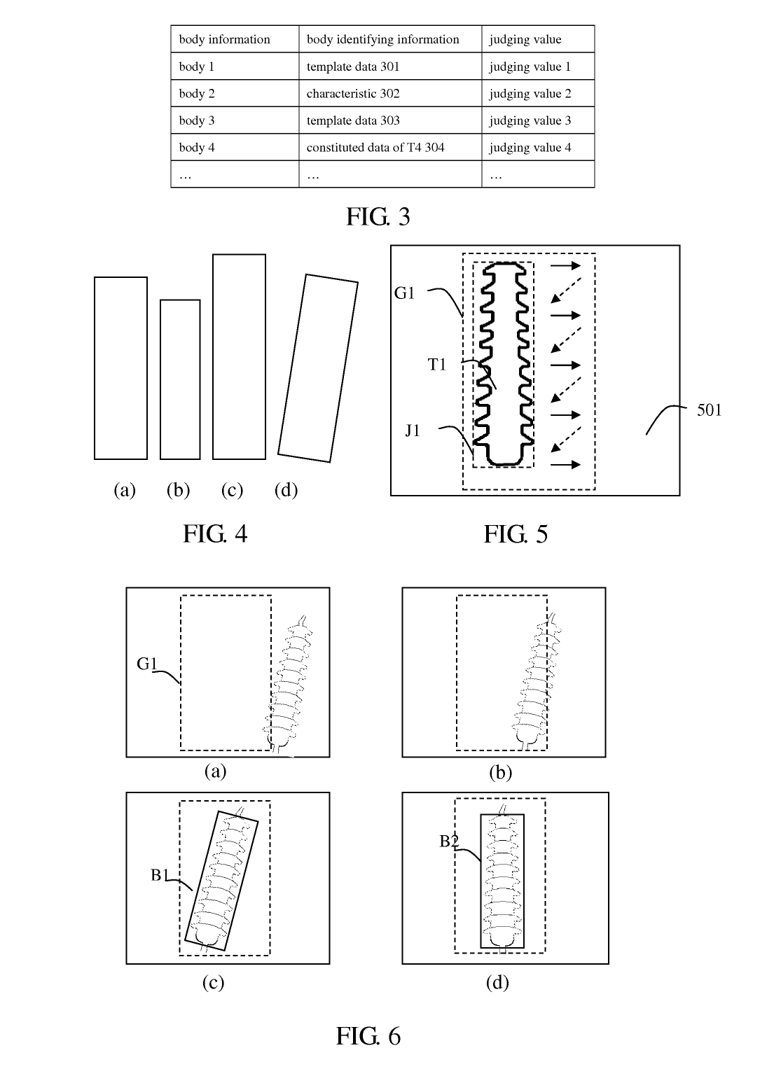

The flash memory 3 stores control programs and different kinds of data used in different control. In the embodiment, in FIG. 3, the data related to calculation of the correlation degree is stored in the storage medium such as the flash memory 3. For example, a database of the body identifying information (table three) may be stored, and body information of each body, the body identifying information, and the specified judging values, which correspond to each other, are stored in the database. In addition, data files with specified formats may store the above information. In the embodiment, the predetermined judging values are prestored in the table three in FIG. 3, or may be prepared by other modes, such as setting by users.

The body information is information related to a body, such as the information representing a place, a type, and a number of the body. In addition, the body information may be the information related to the body, such as an attribution unit, a classified grade (such as a voltage grade or an importance grade), a model, a manufacturer, performance and characteristics, a passed photographing or repairing record, a manufacturing date, or a service life, related to the body. Different applicable body information may be prepared according to different applications.

The communication I/F 4 may be an interface for connecting and exchanging data between the thermal imaging device 100 and an external device according to communication specification such as USB, 1394, or network. The external device may be a personal computer, a server, a PDA (personal digital assistant device), other thermal imaging devices, a visible light photographing device, or a storage device.

The storage card I/F 5 is used as an interface of the storage card 6. The storage card I/F 5 is connected with the storage card 6. The storage card 6 is as a rewritable non-volatile storage, can be detachably installed in a groove of the main body of the thermal imaging device 100, and can record the data such as the thermal imaging data according to the control of a record control part (not shown) of the control part 11.

The image processing part 7 is used for performing specified processing for the thermal imaging data frame acquired by the photographing part 1. For example, as the display timing is achieved every time, it may select and read the frames in each specified time interval from the thermal imaging data frames of the specified time sets temporarily stored in the temporary storage part 2. The image processing part 7 performs processing for converting data to be suitable for displaying or recording, such as modification, interpolation, pseudo-color, synthesis, compression, or decompression. The image processing part 7 may be realized by a DSP, other microprocessors, or a programmable FPGA, or the image processing part 7 may also be integrally formed with the detecting part 8 and the control part 11.

The image processing part 7 is used for performing specified processing for the thermal imaging data frame (the thermal imaging signal) photographed by the photographing part 1 to acquire the image data of the infrared thermal image. In detail, for example, the imaging processing part 7 may perform specified processing such as non-uniformity correction or interpolation for the thermal imaging data frame photographed by the photographing part 1 and then may perform pseudo-color processing for the thermal imaging data frame after the specified processing, to acquire the image data of the infrared thermal image. In one embodiment of the pseudo-color processing, a corresponding range of a pseudo-color plate may be determined according to a range of the thermal imaging data frame AD value or a setting range of the AD value, and the particular color value to which the thermal imaging data frame corresponds in the range of the pseudo-color plate is used as the image data of the corresponding pixel position in the infrared thermal image. The image data acquired after the pseudo-color processing by the image processing part 7 is transferred to the temporary storage part 2 that is used as a buffer storage.

In addition, the image processing part 7 includes an image synthesizing unit (not shown). The image synthesizing unit synthesizes the identification data provided by an identification generating unit 7A and the infrared thermal image generated by the image processing part 7, to generate the image data of the synthesized image. In addition, the image synthesizing unit may perform pseudo-color processing for the thermal imaging signals according to the pixel positions of the identification in the infrared thermal image, to generate the image data reflecting the identification and the infrared thermal image (similar to an overlapping effect). For example, the pseudo-color processing is not performed for the thermal imaging signals of the pixel positions of the identification in the infrared thermal image, and is performed for the thermal imaging signals outside of the pixel positions of the identification, and the image data of the identification is combined, thus to generate the image data for displaying.

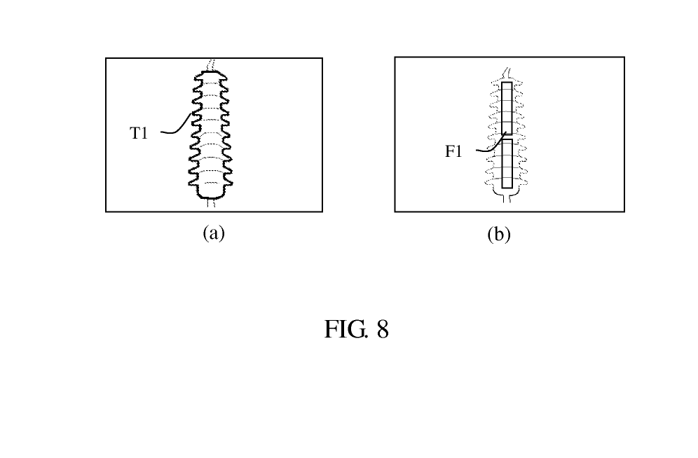

In addition, the image processing part 7 includes an identification generating unit 7A for providing the identification data. The identification may be used for indicating the position of the body thermal image (the body thermal image matching the body identifying information) in the infrared thermal image according to parameters such as a position or a dimension of the detected body thermal image, or reflecting other information such as a dimension or an inclined angle of the body thermal image. The identification may be a point, a line, or a plane. Preferably, the identification corresponds to the specified body, such as an image reflecting the morphological character of a body, i.e. a contour image T1 overlapped on the body thermal image in FIG. 8 (a), thereby facilitating the direct matching of the correlation degree, or an image reflecting a specified analysis area of a body, i.e. an analysis area F1 overlapped on the body thermal image in FIG. 8 (b), thereby facilitating detection that if the analysis area is suitable. At that moment, the identification data and the relative position relation between the identification and the detecting window (such as the position, dimension, or inclined angle of the identification located in the template) may be stored in the table three correspondingly with the body information and the body identifying information. Otherwise, the identification may be generated according to the position, dimension, inclined angle of the detected specified body thermal image located in the infrared thermal image. In addition, the identification may be acquired by different processing for the thermal imaging data in the detecting window. For example, the identification may be acquired by further extracting the contour of the body thermal image included by the thermal imaging data in the detecting window.

The processing performed by the image processing part 7 for the pixels at the pixel positions in the thermal imaging data frame corresponding to the identification may be different from the pseudo-color processing for the thermal imaging signals at other pixel positions for generating the infrared thermal image, thus to generate the image with the identification reflecting the specified body thermal image. For example, the pseudo-color conversion performed for the specified pixel position (such as a contour position) of the thermal imaging data in the detecting window may be different from that for other pixel positions, which is used as the displayed identification. At that condition, the image synthesizing unit for synthesizing the identification image and the infrared thermal image may be removed from the thermal imaging device 100. Further, for example, the pseudo-color conversion (such as different pseudo-color tables) performed for the pixel position of the detecting window is different from that for other pixel positions, which is used as the displayed identification. At that moment, the image synthesizing unit for synthesizing the identification image and the infrared thermal image may be removed from the thermal imaging device 100, or the identification generating unit 7A for acquiring the identification image data may also be removed.

The detecting part 8 calculates the correlation degree between the acquired thermal imaging data frame and the body identifying information. For example, under the control of the control part 11, the detecting part 8 may read the thermal imaging data frame acquired by the photographing part 1 stored in the temporary storage part 2 or read the data (such as the image data of the infrared thermal image acquired after the pseudo-color processing) acquired after the specified processing of the image processing part for the thermal imaging data frame acquired by the photographing part 1 from the temporary storage part 2, to perform the detection of the correlation degree between the data and the registered body identifying information.

In other embodiments, the thermal imaging data frame may be acquired from the externally input data, such as the decompressed thermal imaging data frame received from other thermal imaging devices via the communication I/F 4, and may be acquired from a record medium, such as the thermal imaging data frame acquired by reading a thermal imaging file from the storage card 6.

The thermal imaging data frame for detection may be a thermal imaging signal, image data of the infrared thermal image, array data of temperature values, or other data acquired according to the thermal imaging signal.

In the first embodiment, the detecting part 8 may include a character registering unit, a detecting window setting unit, a detecting unit, and a judging unit (not shown).

The character registering unit is used for registering the body identifying information related to the calculation of the correlation degree. For example, the body identifying information may be registered according to the body identifying information prestored in the storage medium. For example, according to the body identifying information related to the body information selected by users, the body identifying information for the calculation of the correlation degree may be registered. In addition, the users may designate the body identifying information. For example, the body identifying information (such as template data or characteristics extracted from the body area) may be acquired by designating the body area in the displayed image. The registered body identifying information may be stored at a specified position in the temporary storage part 2, or may be stored with a mark to be different from other stored body identifying information.

The body identifying information may be template data (such as template images) for template matching. In addition, the body identifying information may also be the characteristic described by parameters. The characteristics (such as points, lines, or planes) may be a value determined by a state of the pixels contained in a detecting window, such as a ratio of specified pixels in the specified detecting window, an average value of pixel values, a center point or an area of a contour of a specified body. For example, for a body 1 in the table three, the body identifying information is the template data 301. For a body 2 in the table three in FIG. 3, the body identifying information is the characteristic 302. In detailed application, one kind of the body identifying information or a combination thereof may be used according to conditions.

The detecting window setting unit is used for setting the detecting window. For example, according to the detecting area (such as G1 in FIG. 5) in a certain range, a plurality of the detecting windows are set in the detecting area G1, the detecting windows may be the detecting windows with different dimensions, or may be the inclined detecting window. The dimension and inclination of the detecting window may be preset according to the requirement for the photographing quality. In FIG. 4, FIG. 4 (a) shows a standard detecting window, FIG. 4 (b) shows a detecting window with a reduced dimension, FIG. 4 (c) shows a detecting window with an enlarged dimension, and FIG. 4 (A) shows a detecting window inclined according to a specified angle.

To be equal to the dimension of the detecting window, the template image may be used in a reduced, enlarged or inclined state, or the template image with the dimension equal to the window dimension may be prepared and stored for use. In addition, the thermal imaging data in the detecting window may be used in a reduced, enlarged, or inclined state, to correspond to the template image. The detecting window is not limited to be square, or may have other shapes, which may be determined according to the shape of the template image.

The detecting area may be set according to photographing customs of the users, may be prestored and related to the body information, or may be generated according to the position of the previous identification. The specified detecting area may not be set, and the range of the thermal imaging data frame is as the detecting area. The multiple detecting windows may be set according to the position and dimension designated by the users. The multiple detecting windows are not necessary, and only one detecting window may be set.

In the infrared detection applied field, there are a large amount of devices with different names and similar shapes in a substation. To avoid misleading the users and incorrectly photographing, the detecting area may be set preferably. As the identification of the detecting area is overlapped and displayed on the infrared thermal image, the users may understand the approximate position and dimension of the body thermal image to be photographed, thereby facilitating photographing. However, the detecting area may not be shown.

The detecting unit compares the thermal imaging data in the read thermal imaging data frame based on the detecting window and the body identifying information, to acquire a correlation degree value for evaluating the similar extent. When there are multiple detecting windows, the detected maximum correlation degree value may be as the correlation degree value of the thermal imaging data frame.

The detection of the detecting part 8 may be based on template matching, and the detecting part 8 may calculate and compare the correlation degree based on the thermal imaging data in the detecting window and the template image. For example, the detecting unit may calculate a sum of difference values of pixels at the corresponding positions in the image data of the infrared thermal image in the detecting window and in the image data of the infrared thermal image as the template, and the smaller the calculated sum of the difference values is, the higher the correlation degree is.

Further, the detection may be based on the matching of the extracted characteristic. The correlation degree may be determined according to the comparison between the template image and the characteristic of the thermal imaging data in the detecting window. For example, a ratio of the specified pixels of the body image extracted from the detecting window is compared with the ratio of the specified pixels in the template image, and the closer the ratio is, the higher the correlation degree is.

The detection of the detecting part 8 may be based on the characteristics described by parameters. The detecting part 8 performs specified calculation to acquire the characteristic of the thermal imaging data in the detecting window and compares the characteristic and a base value (the body identifying information), thus to acquire the correlation degree value. For example, the base value of the characteristic is a pixel ratio of specified pixel values. The detecting unit calculates the pixel ratio of the specified pixel values of the thermal imaging data in the detecting window and compares the calculated ratio with the base value of the characteristic, thus to acquire the correlation degree value therebetween.

Preferably, the contour image is used as the template for matching. The detecting part 8 may perform the following processing to detect if there is the specified body in the thermal imaging data frame. First, the detecting part 8 extracts the thermal imaging data in the detecting window and performs binarization for the read thermal imaging data in the detecting window according to a specified threshold of the AD value. Then, a connected image of the connected pixels with the specified pixel value (1 or 0) is extracted from the binarization image. Then, if the size of the connected image is in a predetermined range is determined. If the size of the connected image is in the predetermined range, the comparing processing is performed between the extracted connected image and the registered template, for example, calculating the sum of the ratio of the overlapping area therebetween in the respective total area, thereby acquiring the value of the correlation degree between the extracted thermal imaging data and the template.

The judging unit judges the correlation degree according to a specified judging value (such as the value correspondingly prestored with the body identifying information). For example, when the correlation degree value reflecting the similar extent with the template exceeds the judging value, the frame is determined to be one frame including the specified body thermal image, that is, the specified body thermal image is detected, thus to acquire the detecting result. In the embodiment, the specified judging value is prestored in the table three in the flash memory 3. However, the users may set the judging value.

In an example of detection, in FIG. 5, the detecting part 8 detects in the specified detecting area G1 of the thermal imaging data frame 501 by moving a window J1 from the left-upper corner to the right-lower corner, cuts the thermal imaging data in the window, and detects the correlation degree of the thermal imaging data and a template image T1. In detail, the window J1 gradually moves from the left end to the right end through a specified value as the window displacement (such as one pixel), is set to return to the left end and move downwards when achieving the right end, and moves rightwards gradually afterwards. To accurately detect the body, a changing range of the size, displacement, and inclined angle of the window is defined in advance. For example, the changing range of the window size may be from 150×50 pixels to 120×40 pixels, the changing range of the window displacement may be from 10 pixels to one pixel, and the changing range of the inclined angle of the window may be 0° to 10° based on a center point. The detecting part 8 gradually changes the window size at each time of five pixels, changes the window displacement at each time of one pixel, and changes the inclined angle of the window at each time of 2°. The detecting part 8 calculates the correlation degree of the template image T1 and the thermal imaging data frame 501, and selects the correlation degree value acquired from the detecting window with the maximum correlation degree value as the correlation degree value corresponding to the thermal imaging data frame 501 after the detection of the all detecting windows.

The above processing method is just an example, and different methods may be used for calculating the correlation degree of the thermal imaging data frame based on the body identifying information.

The display controlling part 9 is used for displaying the image data stored in the temporary storage part 2 on the display part 10. For example, in a standby photographing mode, the infrared thermal images generated by the thermal imaging data frames acquired by photographing are continuously displayed. In a replay mode, the infrared thermal image read and expanded from the storage card 6 is displayed. In addition, different setting information may be displayed. In detail, the display controlling part 9 includes a VRAM, a VRAM control unit, and a signal generating unit (not shown). Further, under the control of the control part 10, the signal generating unit regularly reads the image data (the image data read from the temporary storage part 2 and stored in the VRAM) from the VRAM, and generates video signals to be displayed on the display part 10. In the thermal imaging device 100, the display part 10 may be a liquid display device. However, the invention is not limited thereto. The display part 10 may further be other display devices connected with the thermal imaging device 100, and the thermal imaging device 100 may not include the display part in itself. At that moment, the display controlling part 9 may be an example of an image output part.

In addition, in the embodiment, the display part 10 is used for performing informing when the thermal imaging data frame with the correlation degree greater than the specified judging value is detected. Except the identification for indicating the position of the body thermal image, characters and images may be used for warning, and the correlation degree information may be displayed. For example, the infrared thermal image (displayed together with the dynamic infrared thermal image) acquired by the thermal imaging data frame with the maximum correlation degree in the specified time may be shown, or the informing modes, such as the changes of characters, transparency ratios of images, colors, dimensions, or twinkling states, may follow. The information of the correlation degree may be displayed by converting the correlation degree value into the information indicating the matching degree and facilitating understanding of the users. For example, according to a specified comparing table of the correlation degree value and percentage or a calculating mode (in one embodiment, the percentage value of the correlation degree may be acquired by dividing the sum of ratios of the overlapping area between the extracted contour of the specified body and the contour T1 of the template in the respective total area by 200%), the correlation degree value is converted into a percentage value. Otherwise, the calculated correlation degree value may be directly displayed. To facilitate description, in the following text, the percentage value converted from the correlation degree value or the evaluating value is taken for example. However, the percentage value is not necessary to be converted. Preferably, the information of the correlation degree may be displayed on the identification.

In addition, other informing mode may be followed or performed only. For example, a vibrating part, an indicating light (not shown), an analysis part (not shown), or a diagnosis part (not shown) in the thermal imaging device 100 may be disposed. Based on the control of the control part 11, when the thermal imaging data frame with the maximum correlation degree is detected, the indicating light may generate light changes, the vibrating device may generate vibration, the analysis part may perform analysis and display an analysis result, the diagnosis part may perform diagnosis and display a diagnosis result, the pseudo-color of the infrared thermal image may be changed, or a combination of the above modes may be used for informing, as long as the users can be informed. The informing mode may continue for specified time.

The control part 11 controls the whole action of the thermal imaging device 100, and the flash memory 3 stores control programs and different kinds of data used in different control. The control part 11 may be realized through a CPU, an MPU, a SOC, or a programmable FPGA. In the embodiment, the control part 11 and the display part 10 may be used as the body information selecting part for selecting the body information.

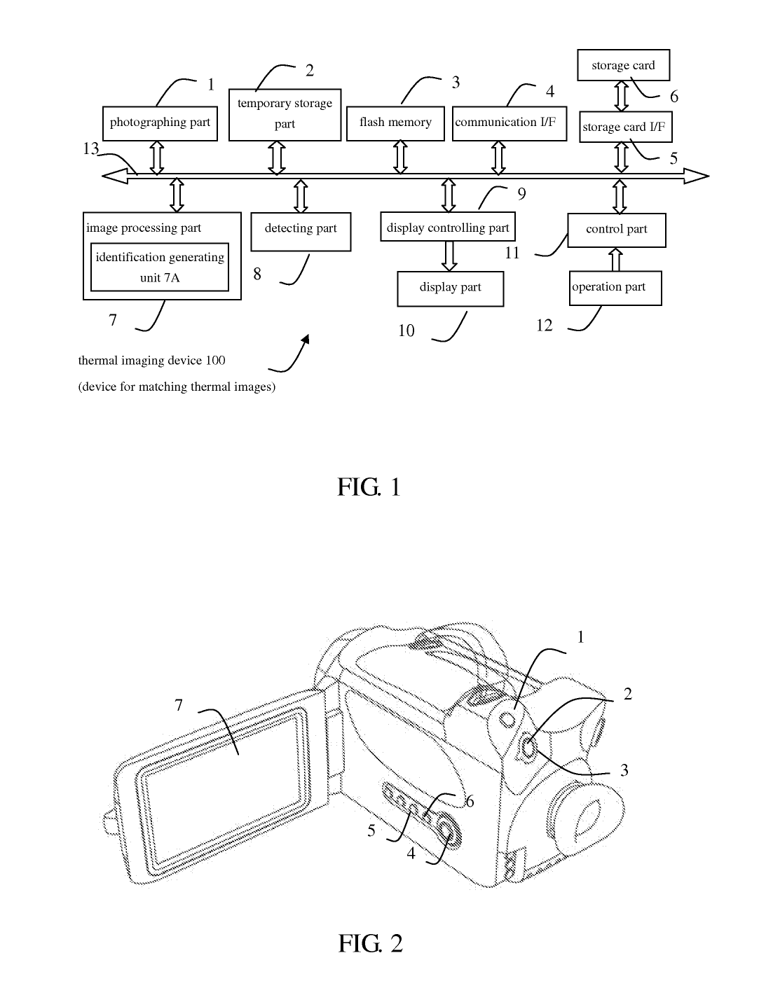

The operation part 12 is used for a user to perform operation such as indicating operation or inputting setting information. The control part 11 executes the corresponding program according to an operation signal of the operation part 12. As shown in FIG. 2, the operation part 12 may include a record key 1, a focusing key 2, an enter key 3, a replay key 4, a menu key 5, and a direction key 6. In addition, a touch screen 7 or a phonic part (not shown) may be used for realizing related operation.

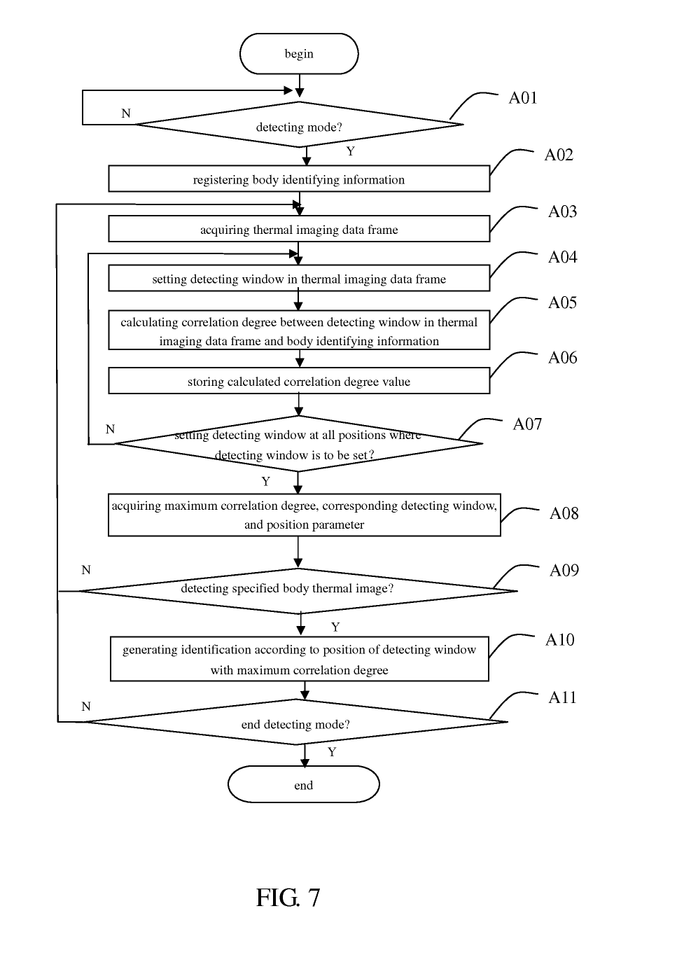

Referring to FIG. 7, the control flows of the detecting mode of the thermal imaging device 100 are described. Referring to FIG. 6, the changes of the display interface during photographing are described. The applied scene may be that a user may photograph the bodies in a substation via a handheld thermal imaging device 100. Based on the control programs and different data used in each control stored in the flash memory 3, the control part 11 controls the whole action of the thermal imaging device 100 and execution of multiple mode processing. When the power is on, the interior circuits of the control part 11 are initialized, and then a standby photographing mode is entered, that is, the photographing part 1 photographs and acquires the thermal imaging data frames that is to be stored in the temporary storage part 2, the image processing part 7 performs specified processing for the thermal imaging data frames acquired by the photographing part 1 to acquire the image data of the infrared thermal image that is to be stored in the specified area of the temporary storage part 2, and the display part 10 continuously displays the infrared thermal image in a dynamic image mode. In the state, the control part 10 continuously monitors whether other modes are switched according to the predetermined operation or shutdown operation is performed. If yes, the corresponding processing control is performed. The detecting mode includes the following control steps.

In step A01, the control part 11 continuously monitors if a user selects the detecting mode.

In the standby photographing mode, the display part 10 displays the dynamic infrared thermal image. In the past, the user may be confused by the morphological character of a body thermal image IR1 and the imaging position, dimension, and angle of the body thermal image in the infrared thermal image. To ensure the photographing quality, the detecting mode is selected via the predetermined operation of the operation part 12. When the control part 11 detects that the user selects the detecting mode (the step A01 is yes), the detecting mode is performed.

In step A02, the character registering unit registers the template data T1 for matching. For example, based on the table three stored in the flash memory 3, the control part 11 allows the body indicating information generated by the body information to be displayed on the display part 10. When a user selects a “body 1” displayed on the display part 10 via the operation part 12 according to the “body 1” at the scene, according to the selection of the user, the character registering unit determines the body identifying information for matching, reads the template data 301 from the flash memory 3, and transfers the data to the temporary storage part 2.

In step A03, the thermal imaging data frame is acquired, and the thermal imaging data frame acquired by the photographing part 1 is transferred to the temporary storage part 2.

Then, in step A04, the thermal imaging data frame photographed and acquired instantly by the photographing part 1 may be read from the temporary storage part 2, and the detecting window setting unit sets the detecting window. For example, a detecting window may be first set at the left-upper corner of the specified detecting area G1.

In step A05, the calculation of the correlation degree between the thermal imaging data in the detecting window and the body identifying information is performed.

Based on the detecting window set by the detecting window setting unit, the detecting part 8 extracts the thermal imaging data in the detecting window, and calculates the correlation degree between the thermal imaging data and the template registered by the character registering unit. For example, according to the comparison between the contour of the specified body thermal image extracted from the thermal imaging data in the detecting window and the contour image T1 (the template image acquired by the template data 301), a sum of the ratios of the overlapping area therebetween in the respective total area is calculated.

Further, in step A06, the acquired correlation degree value is stored.

In step A07, the detecting part 8 determines if the calculation of the correlation degree for all detecting windows is performed when the detecting window is set in the thermal imaging data frame. If there is a surplus area without calculation of the correlation degree (no in the step A07), return to the step A04. The detecting window setting unit allows the position of the detecting window to move along a predetermined direction for specified pixels, and sets the position as the next position of the detecting window. The subsequent processing is repeated.

In addition, when the frame similar to the template is found from the thermal imaging data frame, the similar detection may also be performed for the detecting window after enlarged, reduced, and inclined for a specified angle.

If the calculation of the correlation degree is performed for all detecting windows set in the thermal imaging data frame (yes in the step A07), in step A08, the detected maximum correlation degree value and the position parameter of the corresponding detecting window are acquired. Further, in step A09, if the correlation degree is smaller than the specified judging value, the detecting part 8 determines that the specified body thermal image is not detected, return to the step A03, or jump to step A11 and return to the step A03 if not exited. The subsequent processing is repeated, and the displayed infrared thermal image is shown in FIGS. 6 (a), (b). Since the matched body thermal image is not detected in the detecting area G1, there is no identification in the displayed infrared thermal image. When the correlation degree detected in the step A09 is greater than the specified judging value, enter into step A10.

In step A10, in the embodiment, the identification is generated according to the position of the detecting window with the maximum correlation degree. For example, the identification may be generated directly according to the position and dimension of the detecting window. The generated identification is synthesized with, such as overlapped on, the infrared thermal image acquired by the thermal imaging data frame, and then is displayed, such as the identification B1 and B2 in FIG. 6 (c) and FIG. 6 (d).

Further, the position parameter of the position, dimension, and inclined angle of the detected body thermal image is not limited to the position parameter of the detecting window. For example, the characteristic of the thermal imaging data in the detecting window may be further extracted, such as the contour of the body, to acquire more accurate position parameters, and the identification may be set according to the position parameter.

In step A11, if the detecting mode is exited is determined. If yes, end the detecting mode. If no, return to the step A03, and repeat the above processing. Thus, for the thermal imaging data frame acquired by continuous photographing, when the thermal imaging data frame with the correlation degree greater than the specified judging value is detected, the users may be informed continuously, without subjectively judging the morphological character of the body thermal image, thereby reducing the photographing workload, and avoiding photographing wrong parts and angles.

Based on the thermal imaging data frames continuously acquired by the acquiring part, the detecting part 8 detects if there is the specified body thermal image and calculates the specified information related to the specified body thermal image. For example, The detecting part 8 may detect the continuously acquired thermal imaging data frames in turns or detect the thermal imaging data frames read from the specified interval, or may perform lessening processing before detecting the thermal imaging data in the read thermal imaging data frame or in the detecting window, thereby reducing processing load followed by the detection.

Further, the image with the identification reflecting the position of the specified body thermal image located in the infrared thermal image is generated, which may be acquired according to the infrared thermal image acquired by the thermal imaging data frame where the body thermal image is detected and the generated identification, or may be acquired according to the infrared thermal image acquired by the newly acquired thermal imaging data frame in the specified time and the identification.

Otherwise, the comparison between the correlation degree value and the judging value is not limited to determine if the specified body thermal image is detected. Otherwise, for example, according to the comparing result between the specified information acquired by detection and/or the evaluating value acquired by the specified information and the corresponding comparing value, the specified body thermal image may be detected. The specified information may include the position, dimension, inclined angle, analysis value, correlation degree value of the specified body thermal image, or a combination thereof.

According to the above, in the embodiment, since the specified detecting area is set, the users can be easily understand the photographing range. When the thermal imaging data frame with the correlation degree greater than the specified value is detected, the position of the body thermal image therein is informed, and the users can know that the body thermal image conforming to the requirement is photographed via the identification, facilitating the subsequent storing and analyzing processing and operation, thereby greatly reducing the operation difficulty of the visual aiming and greatly reducing the photographing work strength. Thus, the common users can easily grasp the photographing skill.

### Embodiment Two

The difference between the second embodiment and the first embodiment is that in the second embodiment, the detecting part 8 is used for detecting the specified information of the specified body thermal image in the thermal imaging data frame based on the acquired thermal imaging data frame, and the image processing part 7 generates the identification reflecting the same or different morphological effects according to the specified information acquired by the detecting part 8. The different morphological effects of the identification at least include the difference of a color, a line type, thickness or thinness, a transparency ratio, a shape, a content (such as including different colors), a twinkling state, luminance, constituted data, a position, a dimension, a rotating angle, or indicating information. The specified information at least includes the position, dimension, inclined angle, analysis value, the correlation degree value of the specified body thermal image, or a combination thereof.

In the infrared detection field, since it is considered that the difference of the position, dimension, or inclined angle of the body thermal image in the infrared thermal image corresponds to the different photographing quality, the factors such as the position, dimension, and inclined angle of the body thermal image located in the thermal imaging data frame may be considered as the factors for generating the identification with the different morphological effects, thereby indicating the users to pay attention to the photographing quality.

Further, the detecting part 8 includes a functional unit for detecting an analysis value. The analysis value may be acquired after calculating the detected thermal imaging data frame or the detected body thermal image according to a specified algorithm, may be a temperature value acquired by calculating the thermal imaging data AD values in the detecting window, or may be a temperature comparing value in different analysis areas, such as temperature difference. The specified algorithm may be to calculate the maximum, minimum, or average temperature value in a specified analysis area. When there is the analysis value greater than the specified comparing value (such as a defected threshold) in the body thermal image, the body has defects, and the users need to pay more attention. At that moment, the specified identification instantly arouses the attention of the users, providing important significance of the infrared detection. The analysis value is not limited to the temperature value, may be an AD value, a color value in the pseudo-color thermal image, a ratio of the specified pixel values, or a value acquired by calculating the above values according to a specified formula.

Thereby, when the detecting part 8 is configured to detect the multiple specified information of the body thermal image, the image processing part 7 generates the identification reflecting the same or different morphological effects according to the specified information acquired by the detecting part 8.

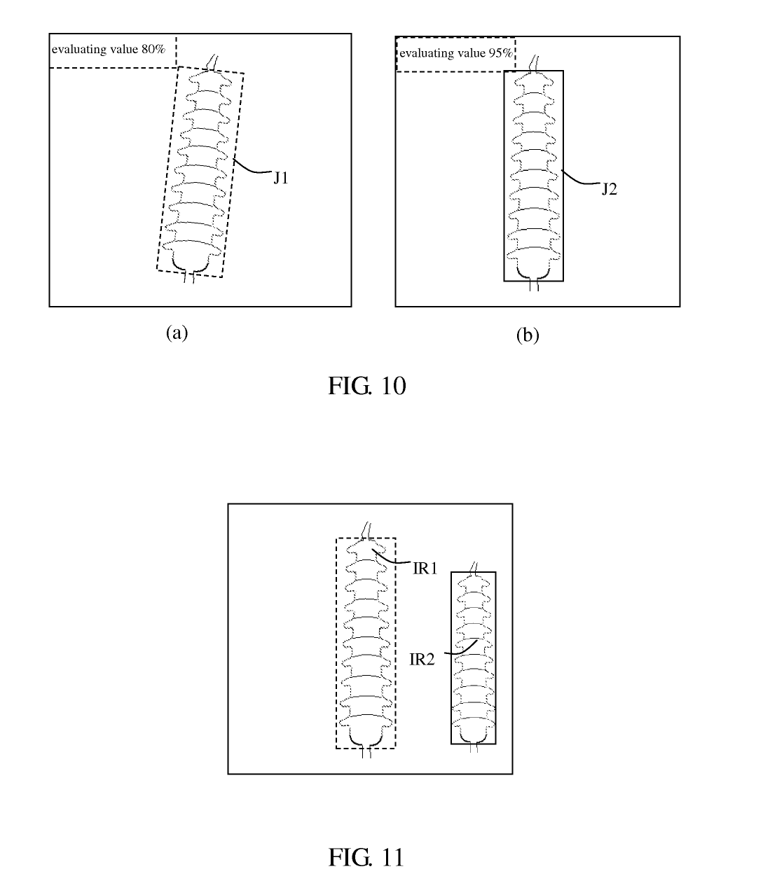

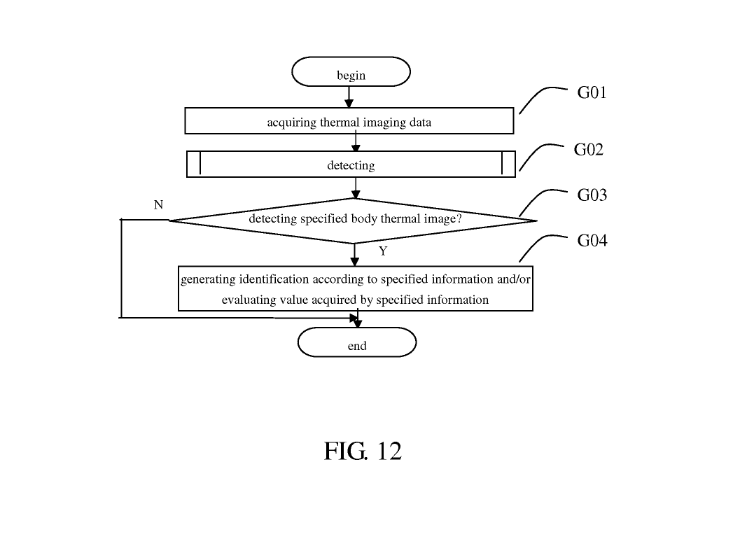

The identification may be generated according to a comparing table of the specified information and the identification data. For example, the different positions, dimensions, and rotating angles may correspond to the different transparency ratios and line types, the different analysis values may correspond to the different colors, and the different correlation degree values may correspond to the different shapes, thereby generating the identification. In FIG. 10, the identification to which the different positions, dimensions, and inclined angles of the detecting window correspond is shown. In FIG. 10 (a), the detecting window (as the identification) corresponds to a dotted line, and in FIG. 10 (b), the detecting window (as the identification) corresponds to a full line.

For example, in FIG. 11, in the embodiment, when the detecting part 8 detects the multiple bodies, the image processing part 7 may generate the identification for each body. The detecting part 8 detects that there is the AD value of the thermal imaging data greater than the specified value in the body thermal image IR2, the analysis value equal to or greater than the specified value corresponds to red, and the analysis value smaller than the specified value corresponds to blue. Therefore, the identification of IR2 is displayed to be red (a full line is an example), and the identification of IR1 is displayed to be blue (a dotted line is an example). In addition, at this condition, the identification of IR2 may be only shown.

Further, a comprehensive evaluating value may be acquired according to the specified information. For example, the specified information in the detected information corresponds to different coefficients, and the evaluating value may be acquired by combining the coefficient and other specified information in the detected information. Otherwise, the evaluating value may be acquired by weighting according to the weighted values of different information. The final evaluating value may be acquired via different calculating modes.

Then, the image processing part 7 (the identification generating unit 7A) may generate the identification according to a comparing table of the evaluating value and the identification data. The identification data includes the parameter or data for differentiating the identification according to the color, line-type, transparency ratio, twinkling state, or different identification types (such as a square, a circle, a contour, or an analysis area) of the identification to which each interval corresponds.

For example, as shown in FIG. 10, in FIG. 10 (a), the window coefficient of a detecting window J2 is 0.95, and in FIG. 10 (b), the window coefficient of a detecting window J1 is 0.8. The evaluating value is equal to the product of the correlation degree value and the window coefficient. Therefore, when the thermal imaging data with the same correlation degree is detected in the two windows, the combination of the correlation degree value and the evaluating value of the detecting window J2 (such as converting to 95%) may be greater than the combination of the correlation degree value and the evaluating value of the detecting window J1 (such as converting to 80%). The identification with different morphological effects may be acquired according to the line type to which the evaluating value corresponds (95% corresponds to a full line, 80% corresponds to a dotted line).

In addition, the evaluating value acquired according to the part information in the detected specified information may be generated, and the identification may be generated according to a comparing table including the evaluating value, the specified information that is not used for generating the evaluating value, and the identification data.

Preferably, the comparing table of the specified information and/or the evaluating value acquired by the specified information and the identification data may be prepared according to different bodies, and the table may be correspondingly stored with the body information and the body identifying information in table three.

In addition, the different specified information and/or the evaluating value acquired by the specified information may correspond to the same identification, which is different from the indicating information. The content, color, transparency ratio, and twinkling state of the indicating information may be different. The indicating information may be one part of the identification, or may be displayed at other area of the display part.

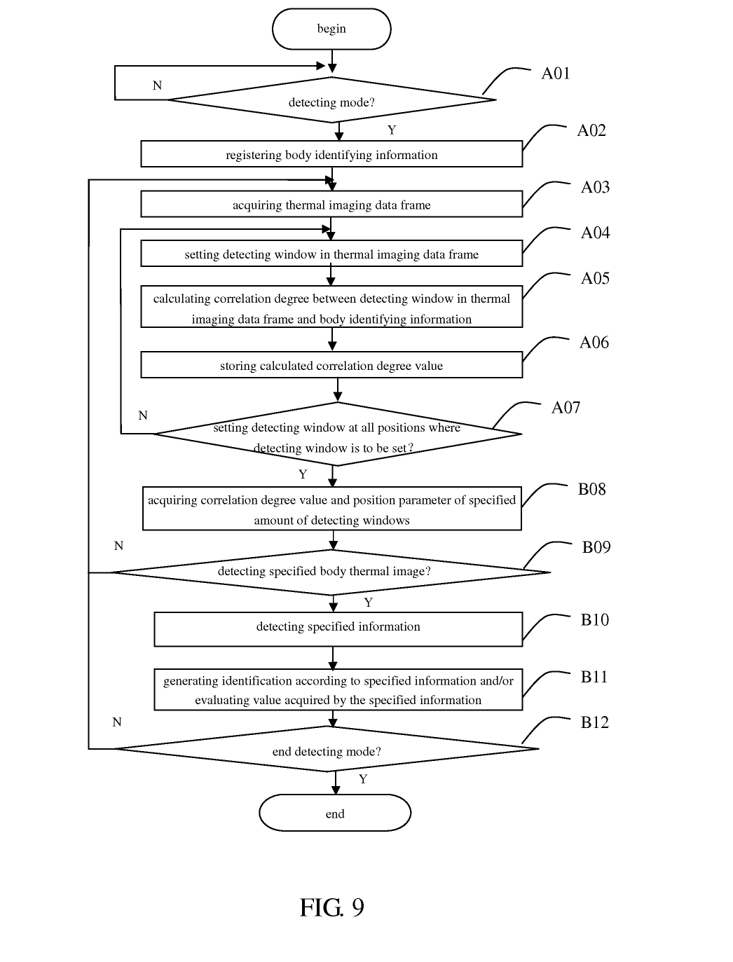

Referring to FIG. 9, the control flows (the steps similar to that in the first embodiment is given the same mark in FIG. 7) of the detecting mode of the thermal imaging device 100 in the second embodiment are described. Referring to FIG. 10, the changes of the display interface during photographing are described.

Steps A01 to A07 are similar to the steps A01 to A07 in the first embodiment.

Therefore, the description is omitted.

In step B08, the detecting part 8 acquires the correlation degree values of the specified amount of the detecting windows in the thermal imaging data frame and the corresponding position parameters.

In step B09, if the correlation degree acquired from the specified amount of the detecting windows is smaller than the specified judging value, the detecting part 8 determines that the specified body thermal image is not detected, the infrared thermal image is continuously displayed, and return to the step B03 and repeat the following processing. When the correlation degree detected in the step B09 is greater than the specified judging value, enter into step B10.

The difference with the first embodiment is that, the correlation degree value corresponding to the thermal imaging data frame may be the correlation degree value acquired from the detecting window with the maximum correlation degree or may be the correlation degree value acquired from the selected specified amount of the detecting window, and when the detected correlation degree acquired from the multiple detecting windows with the specified distance is greater than the specified judging value, the multiple similar bodies are detected.

In step B10, the detecting part 8 further detects the thermal imaging data in the detecting window in which the correlation degree is greater than the specified judging value, to acquire the specified information, such as the analysis value, related to the generation of the identification. In addition, the more accurate parameter such as the position, dimension, or rotating angle of the body thermal image may be acquired by extracting the contour of the body from the detecting window.

In step B11, the image processing part 7 generates the corresponding identification according to the acquired specified information, such as a comparing table of the evaluating value and the identification. When the detecting part 8 detects the multiple bodies, the identification corresponds to the each one may be generated (as shown in FIG. 11).

Then, the generated identification is synthesized with, such as overlapped on, the infrared thermal image acquired by the thermal imaging data frame and then is displayed.

In addition, the identification with different morphological effects may not be shown, and the detected specified information and the evaluating value may be converted to the indicating information for displaying by which the users may understand easily. For example, the evaluating value may be converted to a percentage (the evaluating value is converted to the percentage) or other modes, such as directly displaying the calculated evaluating value. Otherwise, the different identification may be generated, and the indicating information of the evaluating value may be displayed. In FIG. 10, the displayed evaluating value in FIG. 10 (a) is 80% (corresponding to the identification box of the dotted line), and the displayed evaluating value in FIG. 10 (b) is 95% (corresponding to the identification box of the full line).

Further, the specified evaluating value or the detected specified information may be informed in other ways. For example, when the detected analysis value is greater than the specified comparing value, the indicating light is twinkled. The informing mode may continue for specified time. The informing part may be a vibrating part, an indicating light (not shown), an analysis part (not shown), or a diagnosis part (not shown) in the thermal imaging device 100. Based on the control of the control part 11, when the specified thermal imaging data frame is detected, the indicating light may generate light changes, the vibrating device may generate vibration, the analysis part may perform analysis and display an analysis result, the diagnosis part may perform diagnosis and display a diagnosis result, or a combination of the above modes may be used for informing, as long as the users can be informed.

In step B12, whether the detecting mode is exited is determined. If yes, end the detecting mode. If no, return to the step A02, and repeat the above processing. Thus, for the thermal imaging data frames acquired by continuous photographing, when the thermal imaging data frame with the correlation degree greater than the specified judging value is detected, the users are continuously informed, and the identification with different visual effects may be generated according to the detected specified information, thereby further reducing the photographing workload, avoiding photographing wrong parts, and indicating the specified detecting result.

According to the modification of the second embodiment, on some conditions, if the specified body thermal image is detected is not limited to be determined by the comparison between the correlation degree value and the judging value of the correlation degree. For example, the comparing result between the specified information and/or the evaluating value acquired by detection and the corresponding comparing value may provide a basis for determining if the specified body thermal image is detected or if the identification is to be generated.

According to the above, in the embodiment, since the identification is generated according to the position, dimension, inclined angle, analysis value, the correlation degree value of the specified body thermal image, or a combination thereof, the users can be instantly informed to pay attention to specified conditions, the visual aiming operation difficulty can be greatly reduced, the work strength of photographing can be greatly reduced, and the quality of the finally acquired thermal imaging data frame can be improved. The common users can easily grasp the photographing skill Any product applying to the embodiment of the invention is not necessary to achieve all of the advantages at the same time.

### Embodiment Three

The difference among the third embodiment and the first to second embodiments is that in the third embodiment, the body thermal image is detected in a replay mode of the thermal imaging device 100. This embodiment is also applied to the setting for the identification of the body thermal image in a frozen state and the setting for the identification of the body thermal image when a thermal image processing device (such as a computer) reads thermal imaging files.

In step G01, the thermal imaging data frame is acquired. For example, according to record operation of the users when freezing the image, the thermal imaging data frame instantly acquired by the photographing part 1 is stored to the temporary storage part 2.

In step G02, the thermal imaging data frame is detected, and the information related to the body thermal image is acquired (similar to A03 to A08 in the first embodiment, the description is omitted).

In step G03, according to the detected information, the image with the identification is generated (similar to A10 in the first embodiment, or B10 to B12 in the second embodiment, the description is omitted).

The thermal imaging device 100 is described in the respect embodiment. This invention is not only applicable to the thermal imaging device with the photographing function such as different kinds of portable or on-line photographing thermal imaging devices, but is also applicable to different kinds of thermal image processing devices such as a thermal image processing device (such as a computer, a personal digital assistant, or a display device used in a set of a thermal imaging device with the photographing function) continuously receiving thermal images from outside and processing the thermal images (such as acquiring the thermal imaging data frame according to the time sequence). The thermal image processing device may be a computer, which is wireless or wiredly connected with the thermal imaging device via a communication interface (one example of the acquiring part may be that the thermal image processing device is connected with an external device according to communication specification such as USB, 1394, or network), and continuously receives the thermal imaging data frame output by the connected thermal imaging device. The detection and informing modes are similar to that in the above embodiment, which is without description.

This invention is not limited to acquire the thermal imaging data frame by photographing or from outside, which may also be as one part or functional module in the thermal imaging device or the thermal image processing device, such as acquiring the thermal imaging data frame from other parts.

Further, the whole area of the body may be detected, and the multiple detecting windows composed by the multiple parts by dividing the body may be detected, thereby capable of achieving more accurate detection. During the detection for each part, the corresponding body identifying information (may be templates or characteristics) may be prepared. Otherwise, the detecting unit may acquire the judging result according to the body identifying information and the judging value to which the multiple body identifying information corresponds. For example, the final adjusting result may be acquired according to the weighting value of the multiple characteristics. Otherwise, the detecting unit may first calculate the comparing result between one of the characteristics and the thermal imaging data frame according to the multiple body identifying information, and calculate the comparing result between the next body identifying information and the thermal imaging data frame when the first comparing result is greater than a specified threshold. The final judging result is acquired according to the multiple comparisons. Different methods for detecting the specified body thermal image may be used, and the processing in the above embodiment is just examples.

The above embodiments are described according to a step sequence. However, there are different sequences in different embodiments, which is not limited to the above embodiments. When the control part 11 and the image processing part include multiple processors, some steps may be processed in parallel.

The storage medium storing the body identifying information may be a storage medium in the thermal imaging device 100, such as a non-volatile storage medium, i.e. the flash memory 3 or the storage card 6, or a volatile storage medium i.e. the temporary storage part 2, or may be other storage mediums wiredly or wirelessly connected with the thermal imaging device 100, such as other devices wiredly or wirelessly connected via the communication I/F 4, i.e. other storage devices, a storage medium in a thermal imaging device, a computer, or a network destination.

In one preferred embodiment, the body identifying information is related to the body information, and the different applicable body information may be prepared according to different applications. For example, in the electric power industry, the body information may be recognized information representing the identity of the body, such as the information representing the position, type, and phase of the body, or may be information representing the type of the body. Obviously, the body identifying information is not limited to be related to the body information.

In the invention, a computer (or a device such as a CPU, MPU) with the above functional system or device may be performed by the single program or the program record on the storage device, and the computer may read and run the program record on the storage device to achieve the above functions. Thereby, the program may be provided to the computer or the thermal imaging device via network or different types of record mediums (such as a computer readable medium) as the storage device.

This invention provides a computer program, and the digital signals composing the computer program are record on a readable record medium in a computer or a thermal imaging device, such as a hard disk, a memorizer. The following steps are performed after the program is executed.

An acquiring step is used for continuously photographing to acquire the thermal imaging data frame.

A detecting step is used for detecting if there is a specified body thermal image based on the acquired thermal imaging data frame.

An image processing step is used for generating a dynamic infrared thermal image with the identification reflecting the position of the specified body thermal image located in the infrared thermal image according to the detecting result in the detecting step, based on the acquired thermal imaging data frame.

This invention further provides a readable storage medium storing a computer program for exchanging digital data. The computer program allows the computer in the thermal imaging device to perform the following steps.

An acquiring step is used for continuously acquiring the thermal imaging data frame.

A detecting step is used for detecting if there is a specified body thermal image based on the acquired thermal imaging data frame.

An image processing step is used for generating a dynamic infrared thermal image with the identification reflecting the position of the specified body thermal image located in the infrared thermal image according to the detecting result in the detecting step, based on the acquired thermal imaging data frame.

Although the function block in the figures may be realized via hardware, software, or a combination thereof, the function block may be not necessary to be realized in one-by-one mode. For example, one software or hardware unit may be used for realizing multiple function blocks, or multiple software or hardware units may be used for realizing one function block. In addition, the processing and control functions of parts or whole in the embodiments may be realized via a special-use circuit, a general processor, or a programmable FPGA.

In addition, in the embodiment, the electric power industry as the scene is taken for example, and different fields of the infrared detection are also applied. The above description is just detailed examples (embodiments) of the invention, and different examples and description does not limit the substantive contents of the invention. Further, different embodiments may be taken place and combined to form more embodiments. After reading the description, persons having ordinary skill in the art may make various modifications and changes without departing from the scope and spirit of the invention.

1-21. (canceled)

22. A device for matching thermal images, comprising:
an acquiring part for acquiring a thermal imaging data frame;
a detecting part for detecting if there is a specified body thermal image based on the acquired thermal imaging data frame;
an image processing part for generating an infrared thermal image with an identification according to a detecting result acquired by the detecting part, based on the acquired thermal imaging data frame, the identification at least reflecting a position of the specified body thermal image in the infrared thermal image or reflecting an analysis area to which the specified body thermal image corresponds.

23. A device for matching thermal images, comprising:
an acquiring part for acquiring a thermal imaging data frame;
a detecting part for detecting if there is a specified body thermal image based on the acquired thermal imaging data frame;
an identification generating unit for generating an identification reflecting a position of the specified body thermal image in an infrared thermal image or reflecting an analysis area to which the specified body thermal image corresponds, according to a detecting result acquired by the detecting part and the thermal imaging data frame acquired by the acquiring part.

24. The device for matching thermal images according to claim 22, further comprising:
a body information selecting part for selecting body information based on the body information stored in a storage medium, the storage medium being used for storing the body information and body identifying information related to the body information;
the detecting part for detecting if there is the specified body thermal image according to the body identifying information related to the selected body information.

25. The device for matching thermal images according to claim 22, wherein the acquiring part is used for continuously acquiring the thermal imaging data frame, the detecting part is used for detecting if there is the specified body thermal image based on the continuously acquired thermal imaging data frame, and the image processing part is used for generating the infrared thermal image with the identification according to the detecting result acquired by the detecting part based on the acquired thermal imaging data frame.

26. The device for matching thermal images according to claim 22, wherein the detecting part is used for performing detection based on a specified detecting area in the thermal imaging data frame.

27. The device for matching thermal images according to claim 22, wherein the detecting part acquires specified information related to the specified body thermal image by detection, and the image processing part is used for generating the infrared thermal image with the identification according to the specified information detected by the detecting part and/or an evaluating value acquired by the specified information.

28. The device for matching thermal images according to claim 27, wherein the specified information at least comprises a position, a dimension, an inclined angle, an analysis value, a correlation degree value of the specified body thermal image, or a combination thereof.

29. The device for matching thermal images according to claim 22, wherein the image processing part generates the infrared thermal image with the identification reflecting different morphological effects according to the specified information acquired by the detecting part and/or the evaluating value acquired by the specified information and the thermal imaging data frame acquired by the acquiring part, and the different morphological effects of the identification at least comprise the difference of a color, a line type, thickness or thinness, a transparency ratio, a shape, a content, a twinkling state, luminance, constituted data, a position, a dimension, a rotating angle, or indicating information.

30. The device for matching thermal images according to claim 22, wherein the identification further reflects a dimension, an inclined angle, a morphological character of the specified body thermal image located in the infrared thermal image, or a combination thereof.

31. The device for matching thermal images according to claim 23, further comprising:
a body information selecting part for selecting body information based on the body information stored in a storage medium, the storage medium being used for storing the body information, body identifying information related to the body information, identification data, and a relative position relation between the identification and the body identifying information or a detecting window;
the detecting part for detecting if there is the specified body thermal image according to the body identifying information related to the selected body information,
when the specified body thermal image is detected, the image processing part being used for setting the identification according to the position of the body thermal image in the infrared thermal image, the position and dimension, or the position, dimension, inclined angle, and the relative position relation between the identification and the body identifying information or the detecting window.

32. The device for matching thermal images according to claim 22, further comprising a display controlling part for controlling to display an image acquired by the image processing part.

33. The device for matching thermal images according to claim 22, wherein the device for matching thermal images is a portable thermal imaging device, and the acquiring part is a photographing part for acquiring the thermal imaging data frame via photographing.

34. The device for matching thermal images according to claim 24, wherein the storage medium is disposed in the device for matching thermal images or is a non-volatile storage medium connected with the device for matching thermal images.

35. A method for matching thermal images, comprising:
an acquiring step for acquiring a thermal imaging data frame;
a detecting step for detecting if there is a specified body thermal image based on the acquired thermal imaging data frame;
an image processing step for generating an infrared thermal image with an identification according to a detecting result acquired by the detecting part, based on the acquired thermal imaging data frame, the identification at least reflecting a position of the specified body thermal image in the infrared thermal image or reflecting an analysis area to which the specified body thermal image corresponds.

36. The method for matching thermal images according to claim 35, wherein the acquiring step is used for continuously acquiring the thermal imaging data frame.

37. The method for matching thermal images according to claim 36, further comprising:
a body information selecting step for selecting body information based on the body information stored in a storage medium, the storage medium being used for storing the body information and body identifying information related to the body information;
the detecting step for detecting if there is the specified body thermal image according to the body identifying information related to the selected body information.

38. The method for matching thermal images according to claim 35, wherein the detecting step detects specified information related to the specified body thermal image, and the image processing step is used for generating the infrared thermal image with the identification according to the specified information detected by the detecting part and/or an evaluating value acquired by the specified information.

39. The method for matching thermal images according to claim 35, wherein the specified information at least comprises a position, a dimension, an inclined angle, an analysis value, a correlation degree value of the specified body thermal image, or a combination thereof.

40. The method for matching thermal images according to claim 35, wherein the image processing step generates the infrared thermal image with the identification reflecting the same or different morphological effects according to the specified information acquired in the detecting step and/or the evaluating value acquired by the specified information and the thermal imaging data frame acquired in the acquiring step, and the different morphological effects of the identification at least comprise the difference of a color, a line type, thickness or thinness, a transparency ratio, a shape, a content, a twinkling state, luminance, constituted data, a position, a dimension, a rotating angle, or indicating information.

41. The method for matching thermal images according to claim 35, wherein the identification further reflects a dimension, an inclined angle, a morphological character of the specified body thermal image located in the infrared thermal image, or a combination thereof.
